(19) United States
(12) Patent Application Publication
(10) Pub. No.: US 2002/0129002 A1
(43) Pub. Date: Sep. 12, 2002

(54) eMediaCarts

(76) Inventors: Douglas Wesley Alberts, Carmichael, CA (US); Douglas David Fairchild III, Sacramento, CA (US)

Correspondence Address: Douglas Wesley Alberts, 5005 Beryl Place, Antelope, CA, 95843, US

(21) Appl. No.: 10/032,589

(22) Filed: Oct. 22, 2001

Related U.S. Application Data
(60) Provisional application No. 60/244,044, filed on Oct. 27, 2000.

(51) Int. Cl. G06F 7/00

(52) U.S. Cl. 707/1

(57) ABSTRACT

eMediaCarts are interactive, portable shopping carts, which allow for e-commerce purchasing directly from personal computers, CDs, DVDs, interactive TV systems, or other stand alone or web connected media devices. eMediaCarts can include or access, dynamic databases reproducing functionalities and capabilities of dynamic server web sites, without needing to connect to a server, and can contain the same content as printed versions of catalogs by converting or exporting digital files from print design programs such as Adobe inDesign, Pagemaker, Quark Xpress, Canvas, Freehand et al. to any digital format or document that will support the BuyObjects, such as HTML, Adobe Acrobat, Flash, SVG (Scalable Vector Format), Quicktime, MPEG, PowerPoint, and other documents which can contain interactive URLs including remote server videos (which can be delivered as locally stored portable videos alleviating the concerns of Internet access and security and slowness of inadequate bandwidths). eMediaCarts transform and provide the ability for static data and data received from remote servers to become portable, interactive, purchasing media. eMediaCarts usages include direct mail using file formats such as: HTML, DHTML, XML, PDF, PowerPoint, Word, MPEG and other portable file formats, which can be used within or attached to email or instant messages.

eMediaCarts™: are non-server, standalone (locally hosted or web-connected) non-session memory virtual e-commerce shopping carts for messaging systems, Compact Disc (CD), Digital Video Disk (DVD), Web servers, TV media systems, and other media devices, which are accessible through browsers or messaging clients.

Computer Program (Included in Enclosed CD-Rom)

X-Rom, an eMediaCarts program, is included on the included CD-Rom. A small digital product catalog is also included on the CD so that the X-Rom cart can be demonstrated.

### FIELDS OF THE INVENTION

The eMediaCarts invention is a method of presenting data to potential purchasers, clients and customers. eMediaCarts also include the means to order the products, goods or services.

Existing fields it enhances are the catalog industry, the Internet (web sites, email and instant messaging), and other electronic sales presentation methods, which display digital data (such as interactive TV and wireless). The invention also relates to multimedia presentations, electronic ordering systems, portable digital presentations disseminated on portable media, and portable data presentations, which can be sent over the Internet or other networks that allow a digital display to a remote person.

### BACKGROUND OF THE INVENTION

Invention of eMediaCarts:

eMediaCarts were invented to solve certain problems inherent in existing paper and ink and electronic catalogs.

Although printed catalogs contain photographs and other graphical illustration of the goods and services for sale, they require the customer to either fill out a paper order form and mail or fax it to the vendor, or to telephone the vendor to place the order, leaving no written record of the transaction. Also, printed catalogs cannot be updated when items are sold out, new items added, or prices change, without re-printing and re-distributing the catalog. They also cannot reflect current product availability, like in stock or backorder status.

The above shortcomings are solved with online website catalogs with shopping carts, but websites require the customer to find and come to the site in order to buy. A website cannot be mailed or otherwise distributed to the potential buyers.

eMediaCarts solve these issues by essentially putting the catalog, on any transportable electronic media that can be accessed and presented to the customer electronically. Examples are computer disks or tapes, CDs or DVDs. It can be in the same HTML format as typical web sites, or in any other electronic or digital format that can be displayed electronically. These electronic eCatalogs can be updated remotely, so that prices and product availability is current when the customer views it, even when considerable time has passed since the catalog was created. They can also include time activated sales specials, or even complete new future catalogs that become viewable upon a certain date, adding to or replacing the original catalog.

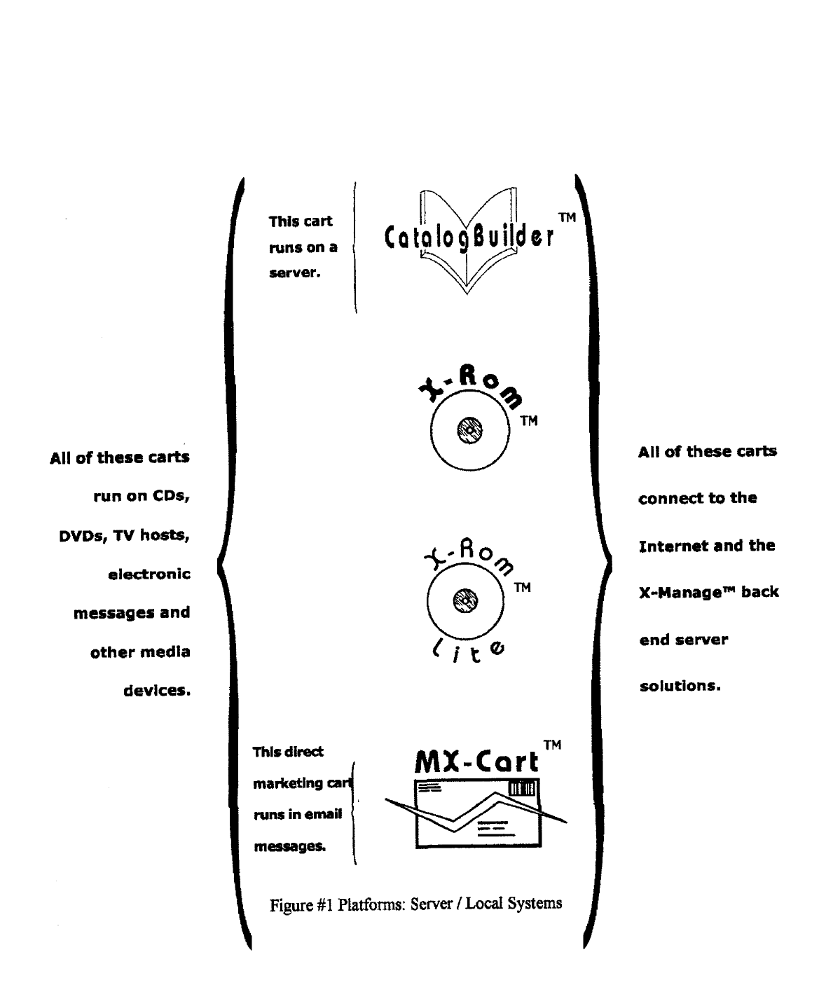

1. eMediacarts are non-server, local device shopping carts with their own software engines for assembling orders, placing orders and purchasing, and do not require a web server, as shown in FIG. 1.

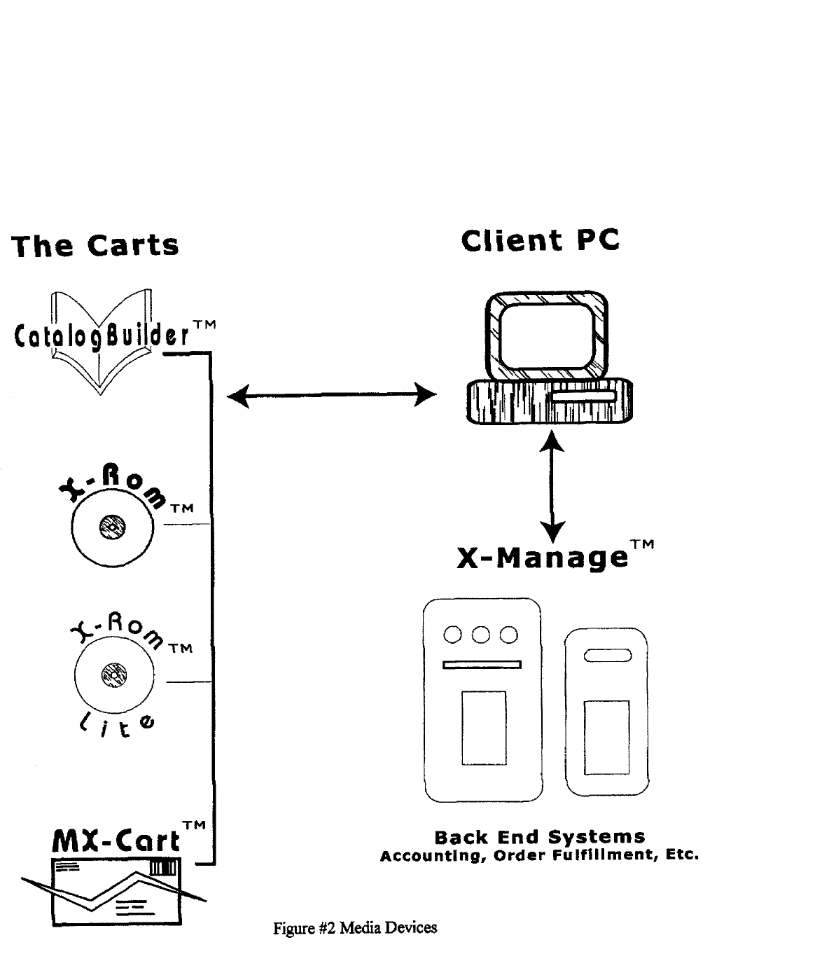

2. Emediacarts are hosted on any electronic storage device or hard drive that supports the file formats they are in, including portable devices such as removable hard disks, compact disks, digital video disks, television media and other media devices or electronic messaging systems that can support them, as shown in FIG. 2.

3. EmediaCarts are implemented as either small applications such as java applets or executable win32 modules incorporating activex controls.

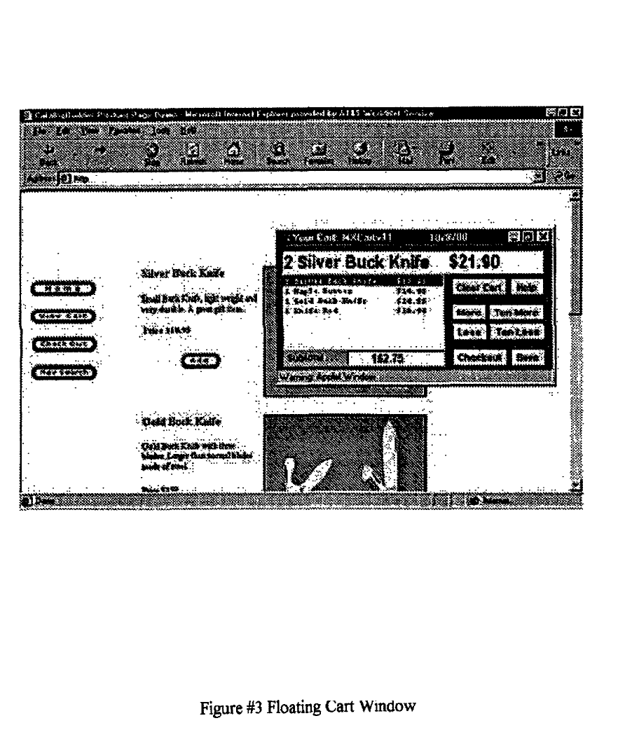

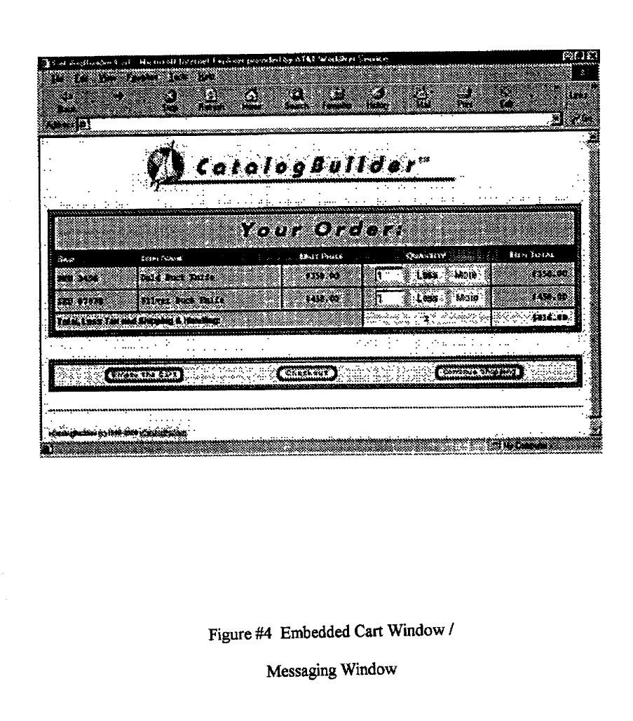

4. Current emediacarts offered by ecatalogbuilders' are catalogbuilder cart, mx-cart, x-rom and x-rom lite cart with items, quantities, prices and other data pertinent to the transaction in either a floating window as in FIG. 3, or embedded as a static or dynamic area within a browser or messaging window as in FIG. 4.

5. Definitions:
Mx-messages are commerce enabled electronic messages.
Ecatalog pages are commerce enabled product pages.
Emedia is the collective term used to describe both mx-messages and ecatalogs.
PDF Engine is a sub application for portable document format ordering, which is based on our proprietary method of using a winsock control bound to a custom transmission control protocol port that is dedicated to accept requests issued by portable document format web links, which are then further processed by the emediacarts custom activex dII.
Buyobjects are code snippets or packages that contain the exact code necessary to make a purchase, complete with identifying icons and the ability to be dragged and dropped from palettes or windows in visual page or document layout and design programs or web authoring programs that support drag and drop technology and can be cut and pasted or dragged and dropped from template pages or documents in layout or design programs that do not support palette drag and drop.
Itransfer is the optional server side component which converts incoming emediacarts orders into either fax format, and faxes them securely to the merchant, or converts them into electronic formats compatible with merchant services gateway providers, for authentication and processing of electronic transactions such as credit cards and echecks.

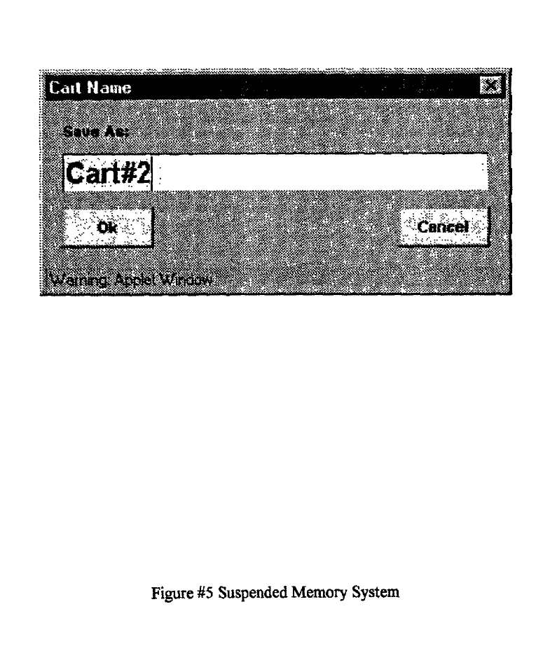

6. The memory storage techniques used are long term cookies and databases which create a suspended memory system to hold and store order data during ordering sessions and to store complete orders which have been saved for later retrieval, for additional ordering modifications at future dates, or to be submitted for back-end processing at a future date as in FIG. 5.

7. Emediacarts have databases and cookie methods that contain entire unprocessed orders/carts on local hosts with unique customer assigned order names or numbers as identification tags, and the dates of the saved carts.

8. Data resources used as product information for emediacarts can be hard-coded or embedded into product pages in various formats, such as HTML, e-mail, text documents that support the coding, and graphical file types such as portable document format pages, scalable vector graphics, shockwave, and flash, or any pages or documents that will support the features and such product pages can be either static files or dynamically generated pages that are produced on the fly from local database contents, and pricing and other product information can be updated from a remote location through optional web-connect methods or through included update files.

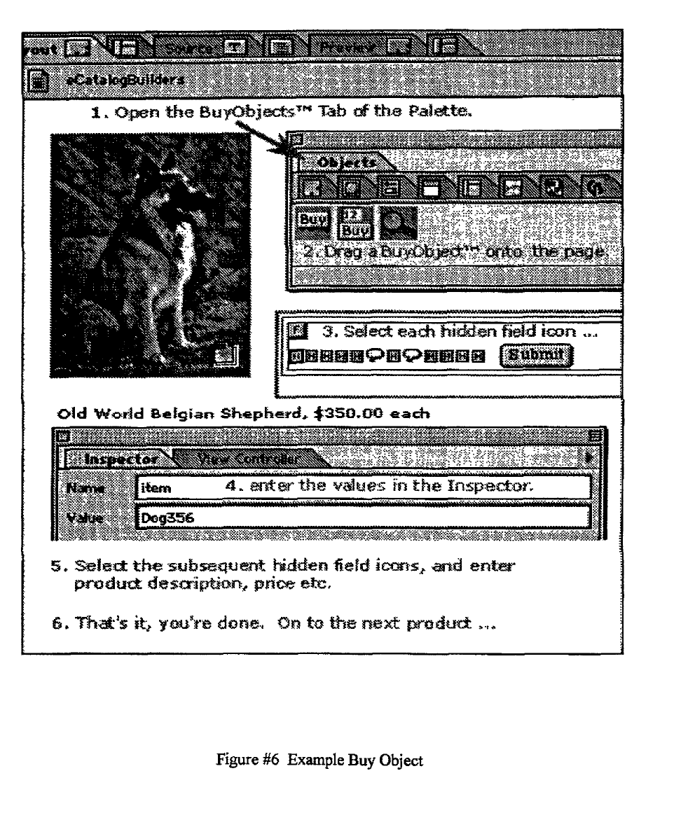

9. The submitting of ordering data from the product pages to the emediacarts is done through buyobjects as shown in FIG. 6, which contain the web links, non-server forms or the forms and link format specific to the file type, such as the forms data format used in portable document format documents, universal resource locator strings, hypertext markup language forms, extensible markup language tags, portable document format web links, and all other available querystring and form field variations available in programming languages, and these buyobjects can either be single product submissions or group product submissions, and the data they contain can be parameters and values, containing numbers, descriptions, styles, colors, quantities, quality, tax info, shipping data, and any qualitative or quantitative options or information pertaining to the purchase.

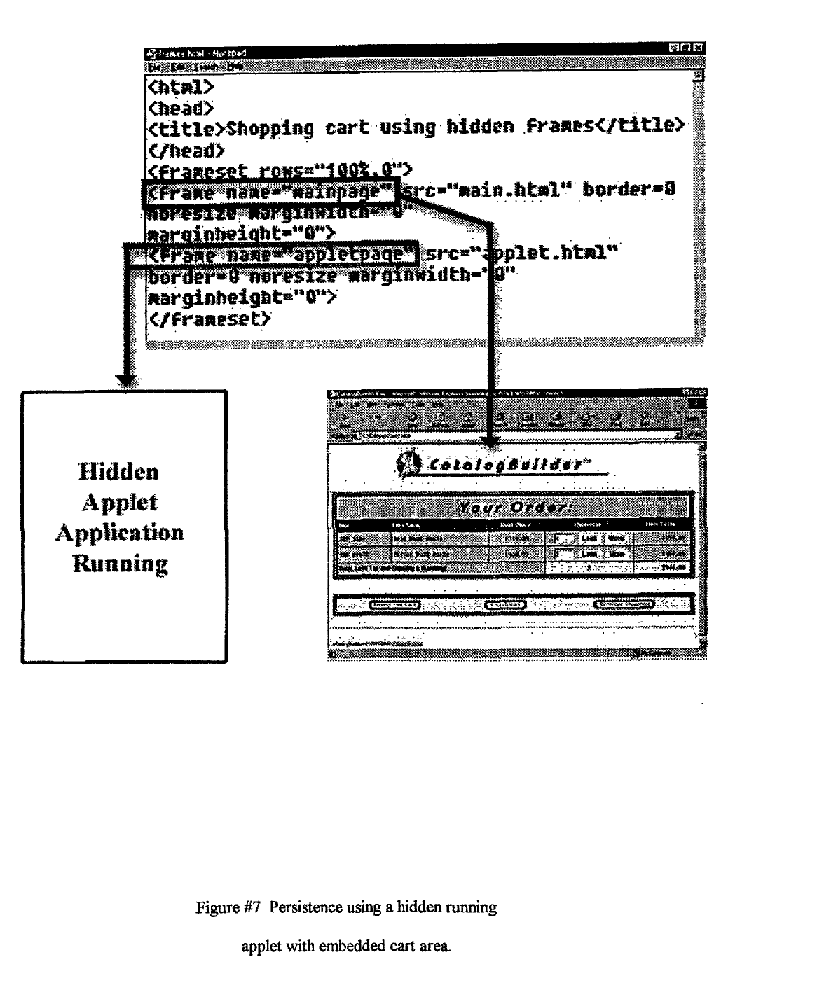

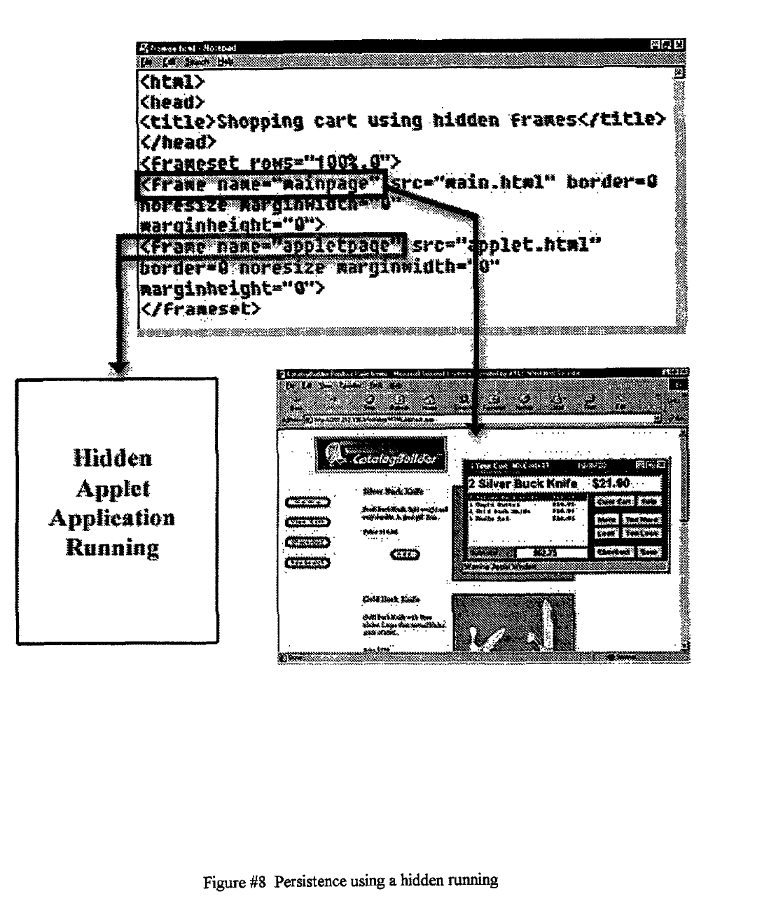

10. Coded applications in hidden frame browser windows provide persistence between linked pages but are not required for single product page catalogs, where the use of the word persistence is in reference to the reloading of the existing cart versus the opening of a new cart during the linking to any additional product pages as shown in FIGS. 7 and 8.

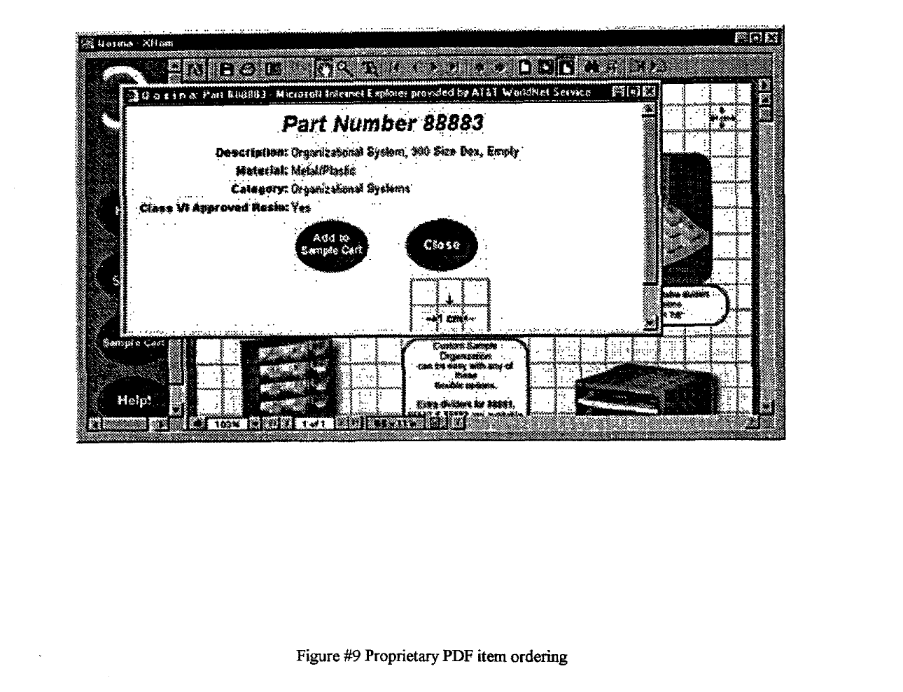

11. Emediacarts' proprietary pdf engine for portable document format ordering is based on our proprietary method of using a winsock control bound to a custom transmission control protocol port that is dedicated to accept requests, issued by portable document format web links, which are further processed by the emediacarts custom activex dII, and is illustrated in FIG. 9.

12. Emediacarts in some cases require liveconnect or other technology that is capable of processing incoming messages from javascript, contained within the product pages.

13. All emediacarts can be web connected to back end merchant services and merchant administration services, including customer information, product updating, product pricing and updating, order history for both customers and the vendors, accounting interfaces, shipping management, taxations management, order faxing through our proprietary fax server, and interfaces to the credit card processor's gateways for credit card authentication and processing through our proprietary itransfer intermediate gateway, and they can be customized to process orders through existing web site shopping carts and back-end services.
